(19) United States
(12) Patent Application Publication
(10) Pub. No.: US 2011/0279780 A1
(43) Pub. Date: Nov. 17, 2011

(54) PROJECTION DISPLAY DEVICE

(76) Inventor: Hiroyuki Saitou, Tokyo (JP)

(21) Appl. No.: 13/138,278

(22) PCT Filed: Jan. 29, 2009
(86) PCT No.: PCT/JP2009/051476

§ 371 Date: Jul. 27, 2011

(51) Int. Cl. G03B 21/14

(52) U.S. Cl. 353/20

(57) ABSTRACT

A projection display device includes: first polarization conversion unit (12) that converts light emitted from a first light source lamp into first polarized light; second polarization conversion unit (23) that converts light emitted from a second light source lamp into second polarized light different from the first polarized light; first lens array (13); second lens array (24); optical path conversion unit (30) that matches the traveling directions of the first polarized light and the second polarized light with each other; third polarization conversion unit (70) that matches the polarizing directions of the first polarized light and the second polarized light emitted from optical path conversion unit (30) with each other; and third lens array (40) into which polarized light emitted from third polarization conversion unit (70) enters. The first light source lamp and the second light source lamp are located so that optical axes thereof can be parallel to each other and away from each other by distance (L) after passage through the optical path conversion unit. Third lens array (40) includes a plurality of lens elements arranged in a matrix, and an arrangement pitch of the lens elements is distance (L).

### TECHNICAL FIELD

The present invention relates to a projection display device, and more particularly to an illumination optical system of the projection display device.

### BACKGROUND ART

To achieve high luminance of a projected image, there is a projection display device that includes two or more light source lamps. Referring to FIG. 6, a configuration of an illumination optical system in the projection display device is described. In the illumination optical system shown in FIG. 6, an elliptic mirror (reflector) and a synthesis mirror are used for synthesizing lights emitted from two light source lamps 201 and 202. Specifically, first reflector 203a and second reflector 203b face each other sandwiching synthesis mirrors 204a and 204b located near the second focal point of the respective reflectors. A light emitting part of first light source lamp 201 is located near the first focal point of first reflector 203a, and a light emitting part of second light source lamp 202 is located near the first focal point of second reflector 203b. As a result, lights emitted from first light source lamp 201 and second light source lamp 202 are deflected in the same direction by synthesis mirrors 204a and 204b to be synthesized. The lights deflected in the same direction are made roughly parallel by collimator lens 205, and then enter first lens array 206.

### SUMMARY OF INVENTION

### Technical Problem

An optical axis of the light emitted from first light source lamp 201 and an optical axis of the light emitted from second light source lamp 202 are shifted by d/2 with respect to the center of first lens array 205 after reflection by synthesis mirrors 204a and 204b.

Thus, an incident angle distribution of a plurality of light fluxes emitted from first light source lamp 201, dispersed by first lens array 206 and superimposed on a LCD (Liquid Crystal Display) by second lens array 207 and a lens located behind second lens array 207 with respect to optical components (dichroic mirror, LCD, and projection lens) is different from that of a plurality of light fluxes emitted from second light source lamp 202, dispersed by first lens array 206 and superimposed on the LCD by second lens array 207 and the lens located behind second lens array 207 with respect to the optical components (dichroic mirror, LCD, and projection lens). When incident angles on the optical components are different, light transmission characteristics change at the optical components.

As a result, when first light source lamp 201 and second light source lamp 202 are both used simultaneously, unevenness of the incident angle distributions on the optical components which are located behind second lens array 207 is mostly canceled. However, when only one of the lamps is used, the unevenness is not canceled, and consequently an illuminance distribution of a projected image becomes uneven.

For example, to simulate an illuminance distribution on an optical path of green light when one lamp is lit, as shown in FIG. 7, a left side of a projected image becomes bright while a right side becomes dark. The illuminance distribution on an optical path of blue light is similar to that on the optical path of the green light. On the other hand, on an optical path of red light, the illuminance distribution is reversed by a relay optical system that includes lenses 208, 209, and 210, and becomes similar to that shown in FIG. 8. In other words, the right side of the projected image becomes bight while the left side becomes dark. As a result, when lights of three colors of red, green and blue are synthesized to display white, red is strong on the right side of an image while red is weak on the left side of an image, and color unevenness occurs.

### Solution to Problem

According to an aspect of the present invention, a projection display device has two light source lamps. The projection display device includes: a first polarization conversion unit that makes uniform the polarizing direction of light emitted from the first light source lamp to convert the light into first polarized light; a second polarization conversion unit that makes uniform the polarizing direction of light emitted from the second light source lamp to be different from that of the first polarized light, and converts the light into second polarized light; a first lens array having a center located on the optical axis of the first light source lamp, into which the first polarized light emitted from the first polarization conversion unit enters; a second lens array having a center located on the optical axis of the second light source lamp, into which the second polarized light emitted from the second polarization conversion unit enters; an optical path conversion unit that transmits the first polarized light emitted from the first lens array and reflects the second polarized light emitted from the second lens array in a direction similar to a transmitting direction of the first polarized light to match traveling directions of the first polarized light and the second polarized light with each other; a third polarization conversion unit that converts one of the polarizing directions of the first polarized light or the second polarized light emitted from the optical path conversion unit matched into the other polarizing directions of the first polarized light or the second polarized light; and a third lens array into which polarized light emitted from the third polarization conversion unit enters. In this case, the first light source lamp and the second light source lamp are arranged so that the optical axes thereof can be parallel to each other and separated from each other by a distance (L) after passage through the optical path conversion unit. The third lens array includes a plurality of lens elements arranged in a matrix, and an arrangement pitch of the lens elements is equal to the distance (L).

According to another aspect of the present invention, a projection display device includes: a first polarization conversion unit that makes uniform the polarizing direction of light emitted from the first light source lamp to convert the light into first polarized light; a second polarization conversion unit that makes uniform a polarizing direction of light emitted from the second light source lamp to be different from that of the first polarized light, and converts the light into second polarized light; a first lens array having a center located on the optical axis of the first light source lamp, into which the first polarized light emitted from the first polarization conversion unit enters; a second lens array having a center located on the optical axis of the second light source lamp, into which the second polarized light emitted from the second polarization conversion unit enters; an optical path conversion unit that transmits the first polarized light emitted from the first lens array and reflects the second polarized light emitted from the second lens array in a direction similar to the transmitting direction of the first polarized light to match the traveling directions of the first polarized light and the second polarized light with each other; a third lens array into which polarized light emitted from the optical path conversion unit enters; and a third polarization conversion unit that converts one of the polarizing directions of the first polarized light or the second polarized light emitted from the third lens array matched into the other polarizing direction of the first polarized light or the second polarized light. In this case, the first light source lamp and the second light source lamp are arranged so that the optical axes thereof can be parallel to each other and can be separated from each other by distance (L) after passage through the optical path conversion unit. The third lens array includes a plurality of lens elements arranged in a matrix, and an arrangement pitch of the lens elements that is equal to distance (L).

### Effects of Invention

According to the present invention, a projection display device having two lights source lumps in which color unevenness do not occur even while one of the lumps is lit is achieved.

The above, other objects, features and advantages of the present invention will become apparent upon reading the following description and accompanying drawings that show an example of the invention.

### BRIEF DESCRIPTION OF DRAWINGS

FIG. 1 A schematic view showing an example of a projection display device according to an embodiment of the present invention.

FIG. 2 An enlarged schematic view showing a configuration near a PBS (polarizing beam splitter) shown in FIG. 2.

FIG. 3 A view showing the result of simulating an illuminance distribution on an optical path of green light when only first light source lamp 10 shown in FIG. 1 is lit.

FIG. 4 A view showing the result of simulating an illuminance distribution on an optical path of red light when only first light source lamp 10 shown in FIG. 1 is lit.

FIG. 5 An enlarged schematic view showing another example of the projection display device according to the embodiment of the present invention.

FIG. 6 A schematic view showing a configuration example of a projection display device that includes a two-lamp illumination optical system.

FIG. 7 A view showing the result of simulating an illuminance distribution on an optical path of green light when only first light source lamp 201 shown in FIG. 6 is lit.

FIG. 8 A view showing the result of simulating an illuminance distribution on an optical path of red light when only first light source lamp 201 shown in FIG. 6 is lit.

### DESCRIPTION OF EMBODIMENTS

### First Embodiment

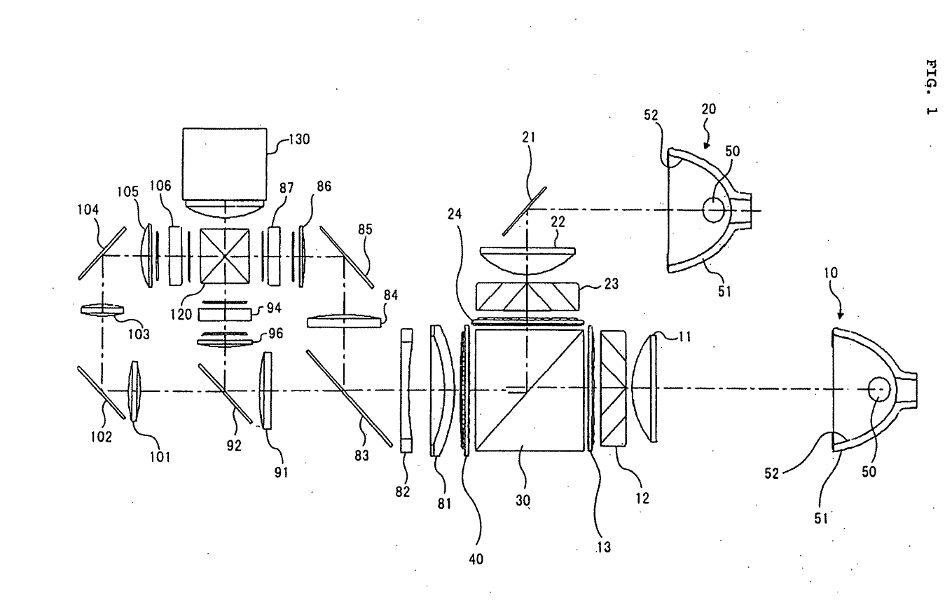

Hereinafter, an example of a projection display device according to an embodiment of the present invention is described. FIG. 1 is a schematic view showing a configuration of the projection display device according to the embodiment. As shown in FIG. 1, the projection display device according to the embodiment has a two-lamp illumination optical system that includes first light source lamp 10 and second light source lamp 20.

On an optical path to which light is emitted from first light source lamp 10, there are arranged first collimator lens 11, first PS converter 12 and first lens array 13 in this order. On an optical path to which light is emitted from second light source lamp 20, there are arranged reflection mirror 21 for optical path conversion, second collimator lens 22, second PS converter 23, and second lens array 24 in this order.

The light emitted from first light source lamp 10 is transmitted through first collimator lens 11 to become roughly parallel light. The light that has become roughly parallel light enters first PS converter 12 to become P-polarized light, and then enters first lens array 13 to be divided into a plurality of light fluxes. On the other hand, the light emitted from second light source lamp 20 is transmitted through second collimator lens 22 to become roughly parallel light. The light that has become roughly parallel light enters second PS converter 23 to become S-polarized light, and then enters second lens array 24 to be divided into a plurality of light fluxes. The plurality of light fluxes emitted from first lens array 13 and the plurality of light fluxes emitted from second lens array 24 are synthesized by a prism polarizing beam splitter (PBS) 30 to be condensed near third lens array 40.

Each of light source lamps 10 and 20 is an extra high-pressure mercury lamp that includes light bulb 50 as a light emitting putt and reflector 51 having a reflection surface. Reflection surface 52 of reflector 51 is elliptic having a rotationally symmetrical axis, and light bulb 50 is located near a first focal point on the rotationally symmetrical axis of reflection surface 52. Hereinafter, the rotationally symmetrical axis of reflection surface 52 of reflector 51 in first light source lamp 10 is referred to as “a first lamp optical axis”. The rotationally symmetrical axis of reflection surface 52 of reflector 51 in second light source lamp 20 is referred to as “a second lamp optical axis”. However, light source lamps 10 and 20 are not limited to the extra high-pressure mercury lamps. For example, metal halide lamps or xenon lamps can be used.

Light emitted from light bulb 50 of first light source lamp 10 is reflected by reflection surface 52 of reflector 51 to be condensed near a second focal point of reflection surface 52. The light condensed near the second focal point enters first collimator lens 11 to become roughly parallel light. First collimator lens 11 is a convex lens, and a focal distance thereof is equal to or roughly equal to a distance between the second focal point of reflection surface 52 of reflector 51 and first collimator lens 11.

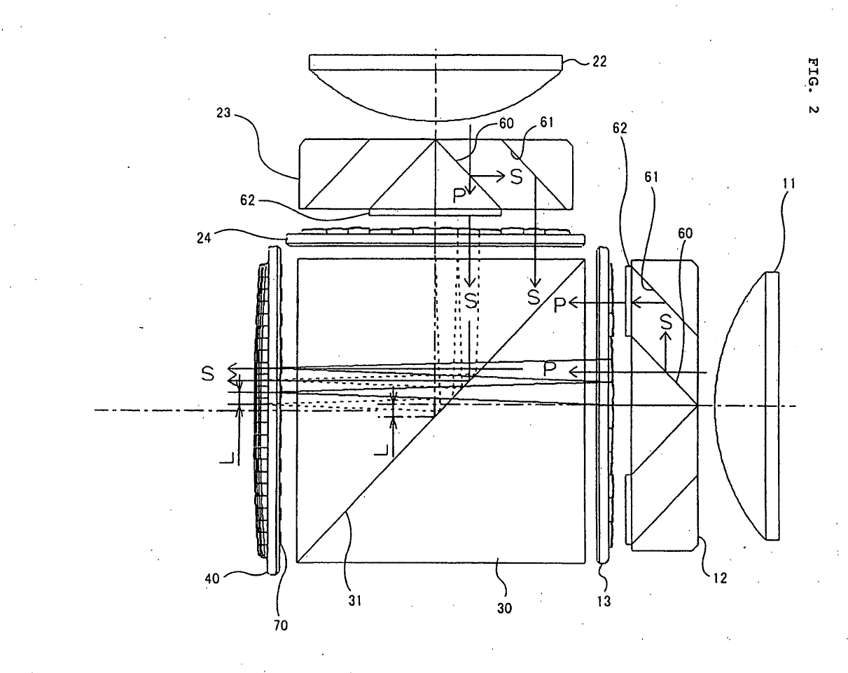

First PS converter 12, into which the light paralleled by first collimator lens 11 enters, has a function of converting the incident light into P-polarized light. Specifically, as shown in FIG. 2, first PS converter 12 includes polarization separation surface 60 for transmitting P-polarized light while reflecting S-polarized light, reflection surface 61 for reflecting the S-polarized light reflected by polarization separation surface 60 in the same direction as that of the P-polarized light transmitted through polarization separation surface 60, and ½ wavelength plate 62 for converting the S-polarized light reflected by reflection surface 61 into P-polarized light. Thus, lights emitted from first PS converter 12 all become P-polarized lights.

Light emitted from light bulb 50 of second light source lamp 20 is reflected by reflection surface 52 of reflector 51 and reflection mirror 21 to be condensed near a second focal point of reflection surface 52. The light condensed near the second focal point enters second collimator lens 22 to become roughly parallel lights. Second collimator lens 22 is also a convex lens, and a focal distance thereof is equal to or roughly equal to a distance between the second focal point of reflection surface 52 of reflector 51 and second collimator lens 22.

Second PS converter 23, into which the light paralleled by second collimator lens 22 enters, has a function of converting the incident light into S-polarized light. Specifically, as shown in FIG. 2, second PS converter 23 includes polarization separation surface 60, reflection surface 61, and ½ wavelength plate 62 identical to those of first PS converter 12. However, in second PS converter 23, ½ wavelength plate 62 is located on an optical path of polarized light transmitted through polarization separation surface 60. Thus, lights emitted from second PS converter 23 all become S-polarized lights.

The polarized light (P-polarized light) emitted from first PS converter 12 enters first lens array 13, while the polarized light (S-polarized light) emitted from second PS converter 23 enters second lens array 24, and then these polarized lights are both condensed near third lens array 40.

First lens array 13 and second lens array 24 are similar in configuration. Specifically, first lens array 13 and second lens array 24 include pluralities of rectangular lens elements arranged in a matrix. In other words, in first lens array 13 and second lens array 24, the pluralities of rectangular lens elements are vertically and horizontally arranged in contact with each other. Intersection points between vertical (longitudinal) center lines of first lens array 13 and second lens array 24 and horizontal (lateral) center lines thereof are referred to as centers of lens arrays 13 and 24. The numbers of lens elements in the longitudinal direction and the lateral direction can be odd or even. In other words, the center of each of lens arrays 13 and 24 can be at the center of a certain lens element or on a boundary between adjacent lens elements.

Third lens array 40 is similar to first lens array 13 and second lens array 24 in inclusion of a plurality of rectangular lens elements arranged in a matrix. However, in third lens array 40, the number of lens elements arranged in a lateral direction is twice as large as that in each of first lens array 13 and second lens array 24, while the number of lens elements arranged in the longitudinal direction is similar to that in each of first lens array 13 and second lens array 24.

As shown in FIG. 1, the center of first collimator lens 11, the center of first PS converter 12, and the center of first lens array 13 are on the optical axis of the first lamp, and the optical axis of the first lamp is vertical to the light entrance surface of PBS 30. The center of second collimator lens 22, the center of second PS converter 23, and the center of second lens array 24 are on the optical axis of the second lamp, and the optical axis of the second lamp is vertical to the light entrance surface of PBS 30.

For convenience of description, light propagated on the optical axis of the first lamp and light propagated on the optical axis of the second lamp are presumed. The optical axis of the first lamp is vertical to the light entrance surface of PBS 30, and hence light propagated on the optical axis of the first lamp continuously travels straight ahead even after entering PBS 30. Polarization separation film 31 (FIG. 2) is formed in PBS 30, and the light (P-polarized light) propagated on the optical axis of the first lamp is transmitted through polarization separation film 31 to continuously travel straight ahead. The light propagated on the optical axis of the second lamp also continuously travels straight ahead after entering PBS 30. However, light propagated on the optical axis of the second lamp is S-polarized light, and hence reflected by polarization separation film 31. The propagation direction (traveling direction) of the reflected light propagated on the optical axis of the second lamp is similar (parallel) to that of the light propagated on the optical axis of the first lamp. In other words, PBS 30 functions as an optical path conversion unit that matches the traveling directions of the light (P-polarized light) propagated on the optical axis of the first lamp and the light (S-polarized light) propagated on the optical axis of the second lamp with each other. In this case, light propagated on the optical axis of the first lamp and light propagated on the optical axis of the second lamp do not match each other but is separated from each other by a distance (L). In other words, first light source lamp 10 and second light source lamp 20 shown in FIG. 1 are arranged so that the optical axis of the first lamp and the optical axis of the second lamp can be separated from each other by distance (L) after passage through PBS 30.

As shown in FIG. 2, in third lens array 40, the plurality of lens elements are arranged at intervals each equal to distances (L), in other words, pitches (L), in the lateral direction. In addition, between PBS 30 and second lens array 40, ½ wavelength plates 70 are arranged at pitches twice (2×L) as large as the arrangement pitches of the lens elements in second lens array 40 at near a condensing point of light fluxs emitted from first lens array 13.

Thus, the P-polarized light emitted from first lens array 13 is converted, after transmission through PBS 30, into S-polarized light by ½ wavelength plate 70 located between PBS 30 and third lens array 40, and then enters third lens array 30. On the other hand, the S-polarized light emitted from second lens array 24 enters, after reflection by PBS 30, third lens array 40 without being converted into polarized light. As a result, the polarizing directions of the lights emitted from two light source lamps 10 and 20 are set in the same direction at third lens array 40 and after.

Referring again to FIG. 1, an optical system at third lens array 40 and latter is similar in configuration to a general projection display device. The light (S-polarized light) emitted from third lens array 40 is transmitted through lens 81 and lens 82 to enter dichroic mirror 83. Dichroic mirror 83 reflects blue light while transmitting yellow light. The blue light reflected by dichroic mirror 83 is reflected by mirror 85 after transmission through lens 84, and then transmitted through lens 86 and other optical elements to reach blue color LCD 87.

The yellow light transmitted through dichroic mirror 83 is transmitted through lens 91 to enter dichroic mirror 92. Dichroic mirror 92 reflects green light while transmitting red light. The green light reflected by dichroic mirror 92 is transmitted through lens 93 and other optical elements to reach green color LCD 94.

The red light transmitted through dichroic mirror 92 is reflected by mirror 102 after transmission through relay lens 101, and transmitted through relay lens 103. The red light is reflected by mirror 104, and then transmitted through lens 105 and other optical elements to reach red color LCD 106.

The blue light, the green light and the red light that have reached the respective LDCs are synthesized again by cross dichroic prism 120 after optical modulation at the LCDs, and then enlarged to be projected via projection lens 130.

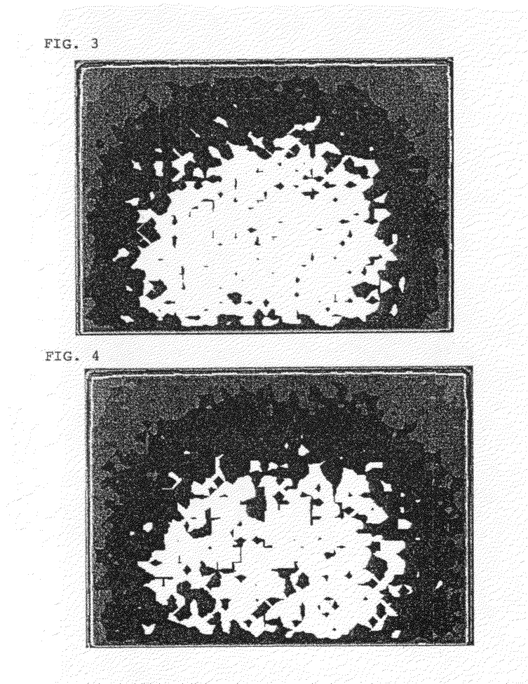

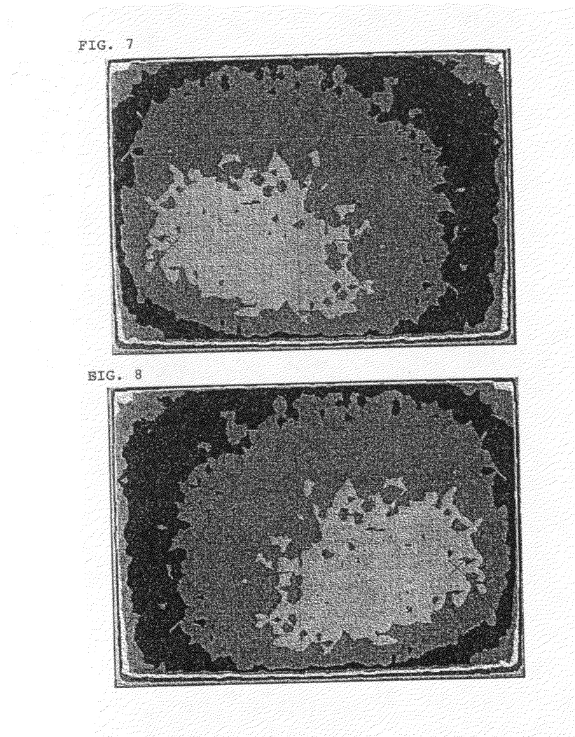

FIG. 3 shows the result of simulating an illuminance distribution on the optical path of the green light when only first light source lamp 10 shown in FIG. 1 is lit. FIG. 4 shows the result of simulating an illuminance distribution on the optical path of the red light when only first light source lamp 10 is lit. Comparisons between FIG. 3 and FIG. 4 and between FIG. 7 and FIG. 8 show that in the projection display device of the present invention, uniformity of illuminance distribution is improved, and the difference in illuminance distribution between the optical path of the green light and the optical path of the red light is greatly reduced.

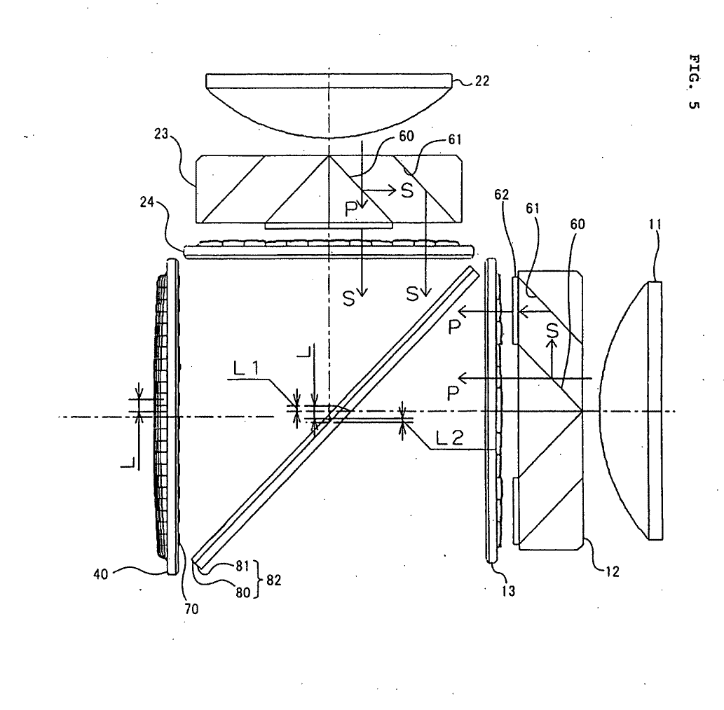

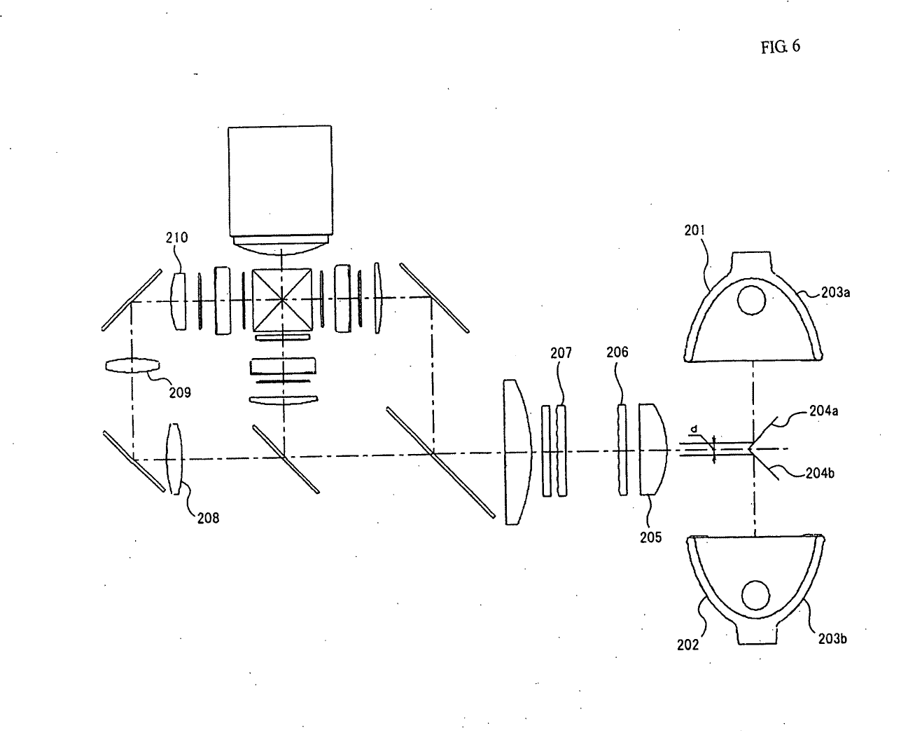

The optical path conversion unit is not limited to the prism polarizing beam splitter shown in FIG. 1 and FIG. 2. FIG. 5 shows another example of the optical path conversion unit. The optical path conversion unit shown in FIG. 5 is flat PBS 82 that includes a pair of substrate glass 80 and cover glass 81, and a wire grid (not shown) formed between substrate glass 80 and cover glass 81. The wire grid in PBS 82 corresponds to polarization separation film 31 of PBS 30 shown in FIG. 2. PBS 82 is tilted by 45 degrees with respect to the optical axes of the first lamp and the second lamp.

The light (P-polarized light) propagated on the optical axis of the first lamp is shifted, during transmission through PBS 82, by L1 from the optical axis of the first lamp according to the refractive index difference between substrate glass 80 or cover glass 81 and air. The light (S-polarized light) propagated on the optical axis of the second lamp is shifted, during reflection by PBS 82, by L2 from the optical axis of the second lamp according to the refractive index difference between the substrate glass 80 or cover glass 81 and air. In this case, light propagated on the optical axis of the first lamp and light propagated on the optical axis of the second lamp do not match each other but are separated by a distance (L). In other words, the first lamp and the second lamp are arranged so that the optical axis of the first lamp and the optical axis of the second lamp can be separated from each other by the distance (L) after passage through PBS 82.

When the optical path conversion unit is realized by the flat PBS shown in FIG. 5, illuminance distributions similar to those shown in FIG. 3 and FIG. 4 can be acquired. Moreover, changing the prism PBS to the flat BPS enables reduction of the optical path conversion unit in size and weight.

1. A projection display device having two light source lamps, comprising:
a first polarization conversion unit that makes uniform a polarizing direction of light emitted from the first light source lamp to convert the light into first polarized light;
a second polarization conversion unit that makes uniform a polarizing direction of light emitted from the second light source lamp so that it is different from that of the first polarized light, and converts the light into second polarized light;
a first lens array having a center located on an optical axis of the first light source lamp, into which the first polarized light emitted from the first polarization conversion unit enters;
a second lens array having a center located on an optical axis of the second light source lamp, which the second polarized light emitted from the second polarization conversion unit enters;
an optical path conversion unit that transmits the first polarized light emitted from the first lens array and reflects the second polarized light emitted from the second lens array in a direction similar to a transmitting direction of the first polarized light to match traveling directions of the first polarized light and the second polarized light with each other;
a third polarization conversion unit that matches the polarizing directions of the first polarized light and the second polarized light emitted from the optical path conversion unit with each other; and
a third lens array into which polarized light emitted from the third polarization conversion unit enters,
wherein the first light source lamp and the second light source lamp are arranged so that the optical axes thereof can be parallel to each other and separated from each other by distance (L) after passage through the optical path conversion unit, and
the third lens array includes a plurality of lens elements arranged in a matrix, and an arrangement pitch of the lens elements is equal to distance (L).

2. A projection display device having two light source lamps, comprising:
a first polarization conversion unit that makes uniform a polarizing direction of light emitted from the first light source lamp to convert the light into first polarized light;
a second polarization conversion unit that makes uniform a polarizing direction of light emitted from the second light source lamp so that it is different from that of the first polarized light, and converts the light into second polarized light;
a first lens array having a center located on an optical axis of the first light source lamp, into which the first polarized light emitted from the first polarization conversion unit enters;
a second lens array having a center located on an optical axis of the second light source lamp, into which the second polarized light emitted from the second polarization conversion unit enters;
an optical path conversion unit that transmits the first polarized light emitted from the first lens array and reflects the second polarized light emitted from the second lens array in a direction similar to a transmitting direction of the first polarized light to match the traveling directions of the first polarized light and the second polarized light with each other;
a third lens array into which polarized light emitted from the optical path conversion unit enters; and
a third polarization conversion unit that matches the polarizing directions of the first polarized light and the second polarized light emitted from the third lens array with each other;
wherein the first light source lamp and the second light source lamp are arranged so that the optical axes thereof can be parallel to each other and separated from each other by distance (L) after passage through the optical path conversion unit, and
the third lens array includes a plurality of lens elements arranged in a matrix, and an arrangement pitch of the lens elements is equal to distance (L).

3. The projection display device according to claim 1,
wherein the optical path conversion unit comprises a prism polarizing beam splitter that includes:
a first light entrance surface into which the first polarized light emitted from the first lens array enters;
a second light entrance surface which is orthogonal to the first light entrance surface and into which the second polarized light emitted from the second lens array enters; and
a polarization separation film that transmits the first polarized light that is incident on the first light entrance surface, and reflects the second polarized light that is incident on the second light entrance surface in a direction similar to the transmitting direction of the first polarized light.

4. The projection display device according to claim 1,
wherein the optical path conversion unit comprises a flat polarizing beam splitter that transmits the first polarized light emitted from the first lens array in a direction similar to an incident direction, and reflects the second polarized light emitted from the second lens array in a direction similar to the transmitting direction of the first polarized light.

5. The projection display device according to claim 2,
wherein the optical path conversion unit comprises a prism polarizing beam splitter that includes:
a first light entrance surface into which the first polarized light emitted from the first lens array enters;
a second light entrance surface which is orthogonal to the first light entrance surface and into which the second polarized light emitted from the second lens array enters; and
a polarization separation film that transmits the first polarized light that is incident on the first light entrance surface, and reflects the second polarized light that is incident on the second light entrance surface in a direction similar to the transmitting direction of the first polarized light.

6. The projection display device according to claim 2,
wherein the optical path conversion unit comprises a flat polarizing beam splitter that transmits the first polarized light emitted from the first lens array in a direction similar to an incident direction, and reflects the second polarized light emitted from the second lens array in a direction similar to the transmitting direction of the first polarized light.
